(19) United States
(12) Patent Application Publication
(10) Pub. No.: US 2023/0127428 A1
(43) Pub. Date: Apr. 27, 2023

(54) GUIDE WHEEL MOUNTING BASE, GUIDE DEVICE HAVING SAME, AND RAIL VEHICLE

(71) Applicant: BYD COMPANY LIMITED, Shenzhen (CN)

(72) Inventors: Liujiang ZHENG, Shenzhen (CN); Zhicheng TAN, Shenzhen (CN); Di LI, Shenzhen (CN); Weida LIU, Shenzhen (CN)

(21) Appl. No.: 18/069,705

(22) Filed: Dec. 21, 2022

Related U.S. Application Data
(63) Continuation of application No. PCT/CN2021/087790, filed on Apr. 16, 2021.

(30) Foreign Application Priority Data
Jun. 24, 2020 (CN) 202010591493.6

(51) Int. Cl. B61F 9/00; B61F 5/42

(52) U.S. Cl. CPC B61F 9/00; B61F 5/42

(57) ABSTRACT

A rail vehicle and a guide device and a guide wheel mounting base used for the rail vehicle are provided. The guide wheel mounting base includes a mounting bracket and a wheel shaft fixing shaft. A through guide hole is provided on the mounting bracket. An outer end of the wheel shaft fixing shaft is connected with a guide wheel. An inner end of the wheel shaft fixing shaft extends through the guide hole. The wheel shaft fixing shaft is movable along an extending direction of the guide hole.

### CROSS-REFERENCE TO RELATED APPLICATIONS

This application is a bypass continuation-in-part of PCT International Application No. PCT/CN2021/087790, filed on Apr. 16, 2021, which claims priority to Chinese Patent Application No. 202010591493.6, filed by BYD Co., Ltd. on Jun. 24, 2020 and entitled “GUIDE WHEEL MOUNTING BASE, GUIDE DEVICE HAVING SAME, AND RAIL VEHICLE”.

### FIELD

The present disclosure belongs to the field of rail transit, and more specifically, to a guide wheel mounting base, a guide device having the same, and a rail vehicle.

### BACKGROUND

When a rail vehicle is turning, a guide wheel near an inner side of a road turn and a guide wheel near an outer side of the road turn are subjected to different pressures, which results in an obvious bump feeling. Therefore, the stability of the rail vehicle is poor.

### SUMMARY

Embodiments of the present disclosure disclose a guide wheel mounting base, configured to mount a guide wheel. The guide wheel is mounted to a guide wheel shaft. The guide wheel mounting base includes:

a mounting bracket, where a guide hole is provided on the mounting bracket; and

a wheel shaft fixing shaft, where an outer end of the wheel shaft fixing shaft is configured to connect with the guide wheel shaft; a central axis of the guide wheel shaft is perpendicular to a central axis of the wheel shaft fixing shaft; an inner end of the wheel shaft fixing shaft extends through the guide hole; and in an extending direction of the guide hole, a space is reserved between the inner end of the wheel shaft fixing shaft and an inner end of the mounting bracket for the wheel shaft fixing shaft to move back and forth along the extending direction of the guide hole.

The present disclosure further provides a guide device, applicable to a rail vehicle. The guide device includes:

a guide frame;

a guide wheel, configured to engage with a side surface of a rail; and

a guide wheel mounting base, where the guide wheel is mounted to the guide frame through the guide wheel mounting base; and the guide wheel mounting base includes:

a mounting bracket, where a guide hole is provided on the mounting bracket;

a wheel shaft fixing shaft, where an outer end of the wheel shaft fixing shaft is configured to connect with the guide wheel shaft; a central axis of the guide wheel shaft is perpendicular to a central axis of the wheel shaft fixing shaft; the wheel shaft fixing shaft is arranged inside the guide hole; and in an extending direction of the guide hole, a space is reserved between an inner end of the wheel shaft fixing shaft and an inner end of the mounting bracket for the wheel shaft fixing shaft to move back and forth along the extending direction of the guide hole;

an elastic component, configured to push the wheel shaft fixing shaft to move from inside toward outside along the extending direction of the guide hole when the wheel shaft fixing shaft reaches an inner end limit position;

a first stop, configured to define the inner end limit position of the wheel shaft fixing shaft in the extending direction of the guide hole; and

a second stop, configured to define an outer end limit position of the wheel shaft fixing shaft in the extending direction of the guide hole.

The embodiments of the present disclosure further provide a rail vehicle, configured to travel on a rail. The rail vehicle includes:

an axle; and

guide devices, connected with the axle and each including:

a guide frame;

a guide wheel, mounted to a guide wheel shaft; and

a guide wheel mounting base, where the guide wheel is mounted to the guide frame through the guide wheel mounting base; and the guide wheel mounting base includes:

a mounting bracket, where a guide hole is provided on the mounting bracket;

a wheel shaft fixing shaft, where an outer end of the wheel shaft fixing shaft is configured to connect with the guide wheel shaft; a central axis of the guide wheel shaft is perpendicular to a central axis of the wheel shaft fixing shaft; an inner end of the wheel shaft fixing shaft extends through the guide hole; and in an extending direction of the guide hole, a space is reserved between the inner end of the wheel shaft fixing shaft and an inner end of the mounting bracket for the wheel shaft fixing shaft to move back and forth along the extending direction of the guide hole;

an elastic component, configured to push the wheel shaft fixing shaft to move from inside toward outside along the extending direction of the guide hole when the wheel shaft fixing shaft reaches an inner end limit position;

a first stop, configured to define the inner end limit position of the wheel shaft fixing shaft in the extending direction of the guide hole; and

a second stop, configured to define an outer end limit position of the wheel shaft fixing shaft in the extending direction of the guide hole.

Additional aspects and advantages of the present disclosure will be given in the following description, some of which will become apparent from the following description or may be learned from practices of the present disclosure.

### BRIEF DESCRIPTION OF THE DRAWINGS

FIG. 1 is a schematic view of a guide device for a rail vehicle in the related art.

FIG. 2 is a schematic view of the guide device for a rail vehicle in the related art from another perspective.

FIG. 3 is a schematic diagram of a rail vehicle according to an embodiment of the present disclosure.

FIG. 4 is a schematic diagram of a guide device according to an embodiment of the present disclosure.

FIG. 5 is a partial enlarged diagram of part A in FIG. 4.

FIG. 6 is a cross-sectional view of a guide wheel mounting base according to an embodiment of the present disclosure.

FIG. 7 is a cross-sectional view of a mounting bracket of the guide wheel mounting base according to an embodiment of the present disclosure.

FIG. 8 is a cross-sectional view of the guide wheel mounting base according to an embodiment of the present disclosure.

FIG. 9 is a cross-sectional view of the guide wheel mounting base according to an embodiment of the present disclosure.

FIG. 10 is a cross-sectional view of the guide wheel mounting base according to an embodiment of the present disclosure.

FIG. 11 is a cross-sectional view of the guide wheel mounting base according to an embodiment of the present disclosure.

### REFERENCE NUMERALS

1. Mounting bracket; 2. Guide rod; 3. Spring; 4. Guide wheel; 5. Guide wheel shaft; 6. Sliding groove;

100. Guide wheel mounting base;

10. Mounting bracket; 11. Buffer guide portion; Ila. Guide hole; 11b. Stop gasket; 12. Support portion; 12a. First turnup; 12b. Support plate; 12c. Second turnup; 13. Second small flexible board; 14. First small flexible board;

20. Wheel shaft fixing shaft; 21. Secondary stop; 211. Stop head; 212. Connecting rod; 2111. Mounting hole, 23. Flexible pad; 231 Inner end surface of flexible pad; 232. Outer end surface of flexible pad;

30. Elastic component; 31. Airbag; 311. Inner protruding portion; 312. Outer protruding portion; 313. Airbag body;

40. Primary stop; 401. Inner end surface of primary stop; 41. Flexible stop; 42. Fixing stop;

50. Wear-resistant bushing; 51. Limiting turnup;

60. Second stop; 61. Groove; 62. Stop boss; 63. Baffle; 64. Rib; 65. Airbag fixing portion; 66. Recessed portion;

70. Mounting plate; 71. Plate body; 711. Outer side surface of plate body; 712. Inner side surface of plate body; 72. Airbag mounting portion; 73. Elastic component mounting portion;

80. Screw;

200. Guide device; 210. Guide frame; 220. Guide wheel; 221. Guide wheel shaft; 222. Guide wheel body;

300. Rail vehicle; 310. Axle;

400. Track; 410. Longitudinal rail; 410a. Inner side surface of longitudinal rail; 410b. Upper surface of longitudinal rail.

### DETAILED DESCRIPTION

To make the technical problems to be solved by the present disclosure, technical solutions, and beneficial effects more comprehensible, the following further describes the present disclosure in detail with reference to the accompanying drawings and embodiments. It should be understood that, the specific embodiments described therein are merely used for explaining the present disclosure instead of limiting the present disclosure.

Embodiments of the present disclosure are described in detail below, and examples of the embodiments are shown in accompanying drawings, where the same or similar elements or the elements having same or similar functions are denoted by the same or similar reference numerals throughout the description. The embodiments described below with reference to the accompanying drawings are exemplary and used only for explaining the present disclosure, and should not be construed as a limitation on the present disclosure.

In the description of the present disclosure, it should be understood that orientation or position relationships indicated by the terms such as “center”, “longitudinal”, “lateral”, “vertical”, “length”, “width”, “above”, “below”, “front”, “rear”, “left”, “right”, “vertical”, “horizontal”, “top”, “bottom” are based on orientation or position relationships shown in the accompanying drawings, and are used only for ease and brevity of illustration and description, rather than indicating or implying that the mentioned apparatus or component needs to have a particular orientation or needs to be constructed and operated in a particular orientation. Therefore, such terms should not be construed as a limitation on the present disclosure. x-axis direction is the longitudinal direction, the x-axis positive direction is front, and the x-axis negative direction is rear; y-axis direction is lateral, the y-axis positive direction is left, and the y-axis negative direction is right; z-axis direction is vertical, the z-axis positive direction is up, and the z-axis negative direction is down; and the xOy plane is the horizontal plane, the xOz plane is the longitudinal vertical plane, and the yOz plane is the lateral vertical plane. Moreover, features modified by “first” and “second” may explicitly or implicitly include one or more features. In the description of the present disclosure, unless otherwise stated, “a plurality of” means two or more than two.

In the descriptions of the present disclosure, it should be noted that, unless otherwise clearly specified and defined, terms such as “mounting”, “interconnection”, and “connection” shall be understood in a broad sense, for example, may be a fixing connection, a detachable connection, an integral connection, a mechanical connection, an electrical connection, a direct connection, an indirect connection by using an intermediate medium, and communication between interiors of two components. A person of ordinary skill in the art may understand the specific meanings of the terms in the present disclosure according to specific situations.

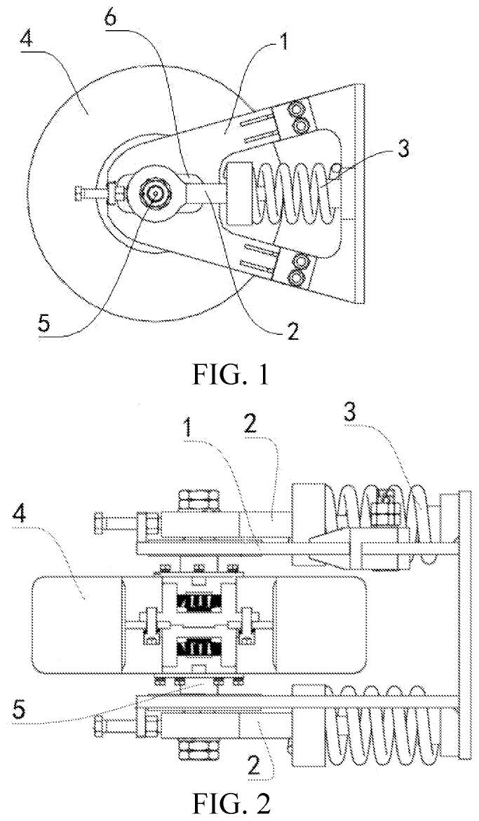

The inventor of the present disclosure found a technical solution through research and analysis, as shown in FIG. 1 and FIG. 2. A guide wheel assembly for a rail vehicle includes a guide wheel mounting base and a guide wheel assembly. The guide wheel mounting base includes a mounting bracket 1, a spring 3, a spring mounting base, and a guide rod 2. The mounting bracket includes two side plates 1 arranged in parallel. The guide wheel assembly includes a guide wheel 4 and a guide wheel shaft 5. The guide wheel 4 is rotatably mounted to the guide wheel shaft 5. Two ends of the guide wheel shaft are respectively mounted to the two side plates. The guide wheel 4 is arranged between the two side plates 1. Sliding grooves 6 with the same length are respectively provided on the two side plates at positions corresponding to each other. The two ends of the guide wheel shaft 5 are respectively mounted in the two sliding grooves 6 on the two side plates. Two springs 3 are arranged. The two springs 3 are respectively mounted to the two side plates 1, and are configured to help the guide wheel shaft 5 slide back in the sliding grooves 6. That is to say, an external force is exerted on the guide wheel 4 to cause the guide wheel shaft 5 to slide from the outside toward the inside along the sliding grooves 6. The springs 3 are configured to reset the guide wheel shaft 5, that is, cause the guide wheel shaft to slide from the inside toward the outside. The sliding grooves 6 limit the guide wheel shaft 5, and the length of each of the sliding grooves 6 is a maximum stroke of the guide wheel shaft 5.

It should be noted that an end close to the guide wheel 4 is the outside, and an end away from the guide wheel 4 is the inside.

In the technical solution, a length direction of the sliding groove 6 is perpendicular to an axial direction of the guide wheel shaft 5, and the sliding groove is an elongated sliding groove. A side wall of the sliding groove 6 is flat. An outer peripheral surface of the guide wheel shaft 5 is cylindrical, and the part of the guide wheel shaft 5 mounted in the sliding groove 6 is in clearance fit with the sliding groove 6. During the operation of the rail vehicle, especially during turning, the guide wheel 4 is subjected to a relatively large lateral force, which is a force perpendicular to the direction of travel of the rail vehicle. The relatively large lateral force causes the guide wheel shaft to be in direct line contact with the side wall of the sliding groove 6 while sliding. Therefore, the side wall of the sliding groove 6 and the guide wheel shaft are seriously worn, which is adverse to the smooth operation of the rail vehicle. In addition, during the turning, the guide wheel 4 is subjected to forces from different directions, resulting in possible point contact between the guide wheel shaft 5 and the side wall of the sliding groove 6. As a result, a relatively large contact stress is generated between the guide wheel 4 and the side wall of the sliding groove 6, which reduces the service lives of the guide wheel shaft 5 and the mounting bracket 1. Since the guide wheel shaft 5 is configured to mount the guide wheel 4, and the guide wheel 4 needs to be rotatably mounted to the guide wheel shaft 5 through a bearing, once the guide wheel shaft 5 is worn, high replacement costs are required.

In addition, in the technical solution, two ends of the sliding groove 6 in the length direction are respectively an inner arcuate wall and an outer arcuate wall. The inner arcuate wall and the outer arcuate wall are respectively configured to limit an inner limit position and an outer limit position of the guide wheel shaft 4. In this case, the guide wheel shaft 5 directly collides with the inner arcuate wall and the outer arcuate wall, which not only causes large noise, but also reduce the lives of the mounting bracket and the guide wheel shaft 5.

Therefore, the above related art is applicable to engineering vehicles with a small freight volume for short-time running but not urban rail transit vehicles with a large freight volume for long-time running. In view of the above, the inventor improved the guide wheel mounting base for a rail vehicle, and obtained the following technical solutions of the present disclosure.

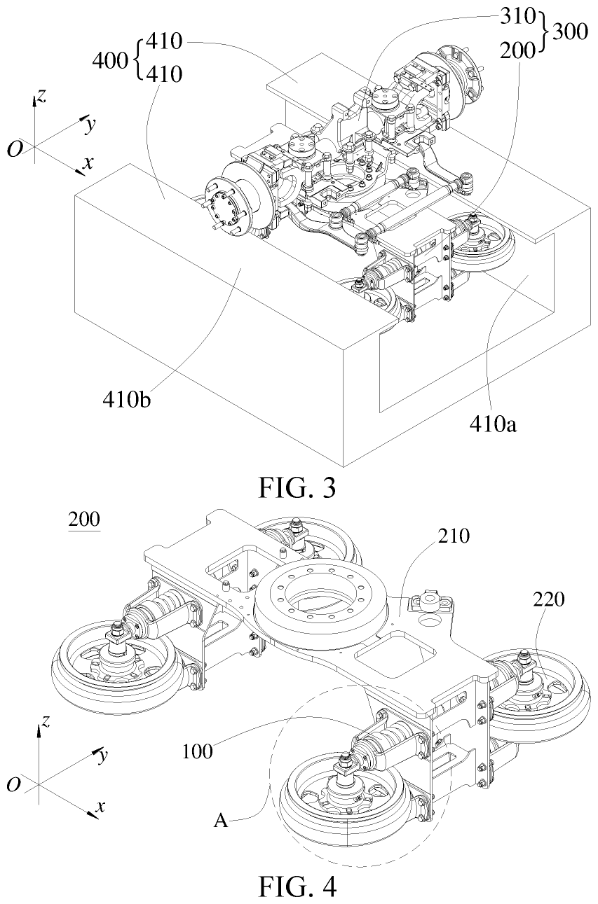

A guide wheel mounting base 100, a guide device 200, and a rail vehicle 300 in the embodiments of the present disclosure are described in detail below with reference to FIG. 3 to FIG. 11. As shown in FIG. 3 and FIG. 4, the rail vehicle 300 is configured to travel on a track 400, and includes the guide device 200. The guide device 200 includes a guide frame 210, a guide wheel 220, and a guide wheel mounting base 100. The guide wheel 220 is mounted to the guide frame 210 through the guide wheel mounting base 100. When the rail vehicle 300 travels on the track 400, the guide wheel 220 is engaged with a side surface of the track 400.

In some embodiments, as shown in FIG. 4, each guide device 200 includes four guide wheels 220. The four guide wheels 220 are distributed on side surfaces of the guide frame 210 in pairs along an advancing direction of the rail vehicle. Each of the guide wheels 220 is mounted on one of the wheel shaft fixing shafts 20 by a guide wheel shaft 221.

As shown in FIG. 3, in some embodiments, the rail vehicle 300 includes a carriage (not shown), and the guide device 200 is mounted to a lower portion of the carriage. In some embodiments, the rail vehicle 300 further includes an axle 310. The axle 310 is arranged on the lower portion of the carriage. The guide device 200 is arranged below the axle 310 and is connected with the axle 310. A walking wheel (not shown) is arranged on each of a left end and a right end of the axle 310. The track 400 includes two longitudinal rails 410 arranged parallel to each other at an interval. The guide wheel 220 is configured to engage with an inner side surface 410a of one of the longitudinal rails 410, and the walking wheel is configured to engage with an upper surface 410b of the longitudinal rail 410. In other embodiments, the rail vehicle 300 may be a straddling monorail vehicle, a suspended monorail vehicle, a rubber wheel tram, or the like.

It should be noted that, in the description of the present disclosure, unless otherwise expressly specified and defined, the term “inner” represents a direction close to the guide frame, and the term “outer” represents a direction away from the guide frame. For example, an “inner end” of a component represents an end close to the guide frame along an extending direction of a guide hole or in a direction parallel to the extending direction of the guide hole, and an “outer end” of the component represents an other end away from the guide frame along the extending direction of the guide hole or along the direction parallel to the extending direction of the guide hole. The same is true for “inner end surface”, “outer end surface”, “inner side”, and “outer side”.

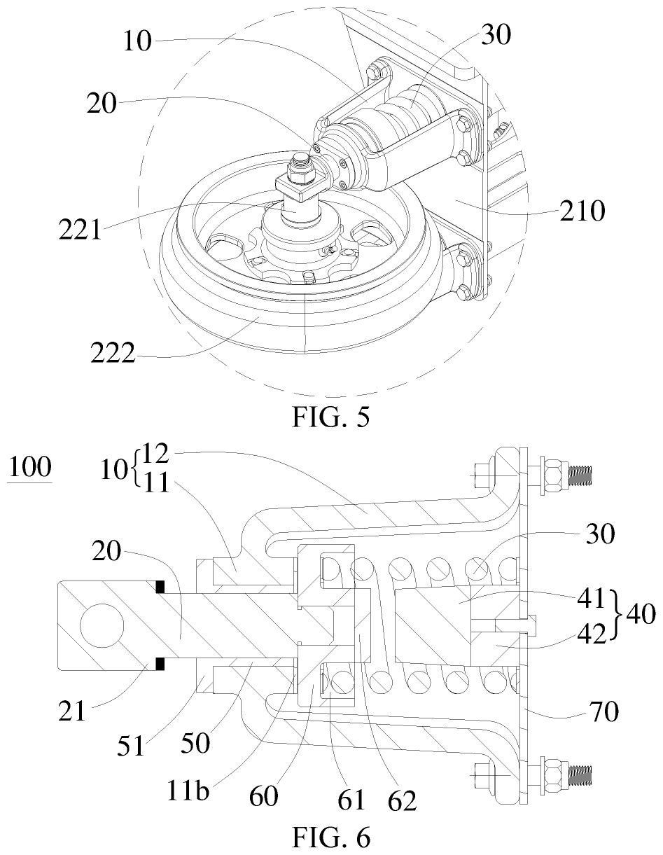

As shown in FIG. 5 to FIG. 11, in some embodiments, the guide wheel mounting base 100 is configured to mount the guide wheel. The guide wheel is mounted to the guide wheel shaft 221. The guide wheel mounting base includes a mounting bracket 10 and a wheel shaft fixing shaft 20. A guide hole 1 la is provided on the mounting bracket 10, and an inner end of the mounting bracket 10 is fixed to the guide frame 210. An outer end of the wheel shaft fixing shaft 20 is configured to be connected with the guide wheel shaft. A central axis of the guide wheel shaft 221 is perpendicular to a central axis of the wheel shaft fixing shaft 20. An inner end of the wheel shaft fixing shaft 20 extends through the guide hole 11a, and the wheel shaft fixing shaft 20 is movable along an extending direction of the guide hole 11a. An elastic component 30 is arranged between the guide frame 210 and the wheel shaft fixing shaft 20.

It should be noted that the extending direction in the present disclosure is an axial direction of the guide hole 11a.

Since the wheel shaft fixing shaft 20 extends through the guide hole 11a and the wheel shaft fixing shaft 20 is movable along the extending direction of the guide hole 11a, a relatively large lateral force, that is, a force parallel to the extending direction of the guide hole 11a on the guide wheel 220 will cause the wheel shaft fixing shaft 20 to move in the guide hole 11a along the extending direction. Since the outer end of the wheel shaft fixing shaft 20 is connected with the guide wheel shaft 221, that is, the guide wheel shaft 221 does not directly contact the guide hole 11a, wear of the guide wheel shaft 221 as a result of lateral sliding is prevented. In addition, since the wheel shaft fixing shaft 20 moves in the guide hole 11a, if an outer diameter of the wheel shaft fixing shaft 20 is the same as an inner diameter of the guide hole 11a, an outer peripheral surface of the wheel shaft fixing shaft 20 contacts an inner peripheral surface of the guide hole 11a. Therefore, the contact area is large, and the contact stress is small. Even if a gap exists between the wheel shaft fixing shaft 20 and the guide hole 11a, a lower portion of the wheel shaft fixing shaft 20 is in line contact with the guide hole 11a, a length direction of the contact line between the wheel shaft fixing shaft 20 and the guide hole 11a is substantially the same as a moving direction of the wheel shaft fixing shaft 20, and a length of the contact line is substantially the same as a length of the guide hole 11a, which is relatively large. In addition, wear of the wheel shaft fixing shaft 20 or the guide hole 11a will change the line contact between the wheel shaft fixing shaft and the guide hole to surface contact, which prevents the large contact stress caused by point contact, and improves the service life of the guide wheel mounting base 100.

In some embodiments, the guide wheel mounting base 100 further includes an elastic component 30, a first stop, and a second stop 60. The elastic component 30 provides buffering during movement of the wheel shaft fixing shaft 20 from the outside toward the inside, and the elastic component 30 is configured to push the wheel shaft fixing shaft 20 to move from the inside toward the outside along the extending direction of the guide hole 11a when the wheel shaft fixing shaft 20 reaches an inner end limit position. The first stop is configured to define a first inner end limit position of the wheel shaft fixing shaft 20 in the extending direction of the guide hole. The second stop 60 is configured to define an outer end limit position of the wheel shaft fixing shaft 20 in the extending direction of the guide hole 11a.

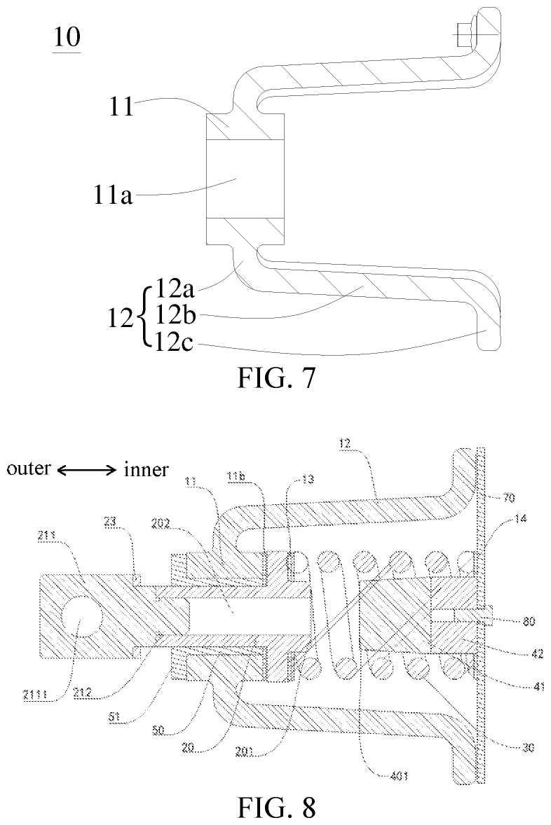

In some embodiments, as shown in FIG. 6 and FIG. 7, the mounting bracket 10 further includes a buffer guide portion 11 at an outer end. The guide hole 11a is arranged on the buffer guide portion 11.

In some embodiments, as shown in FIG. 7, the extending direction of the guide hole 11a is perpendicular to a direction of travel of the rail vehicle 300, that is, perpendicular to an advancing direction along the track 400, so that the elastic component 30 can buffer a lateral force on the guide wheel 220 more effectively, thereby realizing lateral stability of the rail vehicle 300.

In some embodiments, as shown in FIG. 6 to FIG. 10, the first stop includes a primary stop 40. The primary stop 40 is configured to define a first stroke of the wheel shaft fixing shaft 20, that is, configured to define the first inner end limit position of the wheel shaft fixing shaft 20.

In an embodiment, as shown in FIG. 6, an inner end of the primary stop 40 is configured to fixedly connect with the guide frame 210, and an outer end of the primary stop 40 is configured to limit the first stroke of the wheel shaft fixing shaft 20. In an embodiment, the primary stop 40 is a columnar structure. An external force will cause the wheel shaft fixing shaft 20 to move from the outside toward the inside along the extending direction of the guide hole. When an inner end surface of the wheel shaft fixing shaft 20 contacts an outer end surface of the primary stop 40, the wheel shaft fixing shaft 20 reaches the first inner end limit position. In another embodiment, a blind hole coaxial with the primary stop 40 may be further provided in the middle of the primary stop. A closed end of the blind hole is configured to define the first stroke of the wheel shaft fixing shaft 20. For example, an outer diameter of a section of the wheel shaft fixing shaft 20 close to the inner end is not greater than an inner diameter of the blind hole, a length of the section is not less than an axial length of the blind hole, and the inner end of the wheel shaft fixing shaft 20 is arranged coaxially with the blind hole. When an external force causes the wheel shaft fixing shaft to move from the outside toward the inside along the extending direction of the guide hole 11a until the inner end surface of the wheel shaft fixing shaft 20 contacts the closed end of the blind hole, the wheel shaft fixing shaft 20 reaches the first inner end limit position. In these embodiments, the elastic component 30 may be a spiral spring or other types of elastic components, and the elastic component is sleeved on an outer periphery of the primary stop 40.

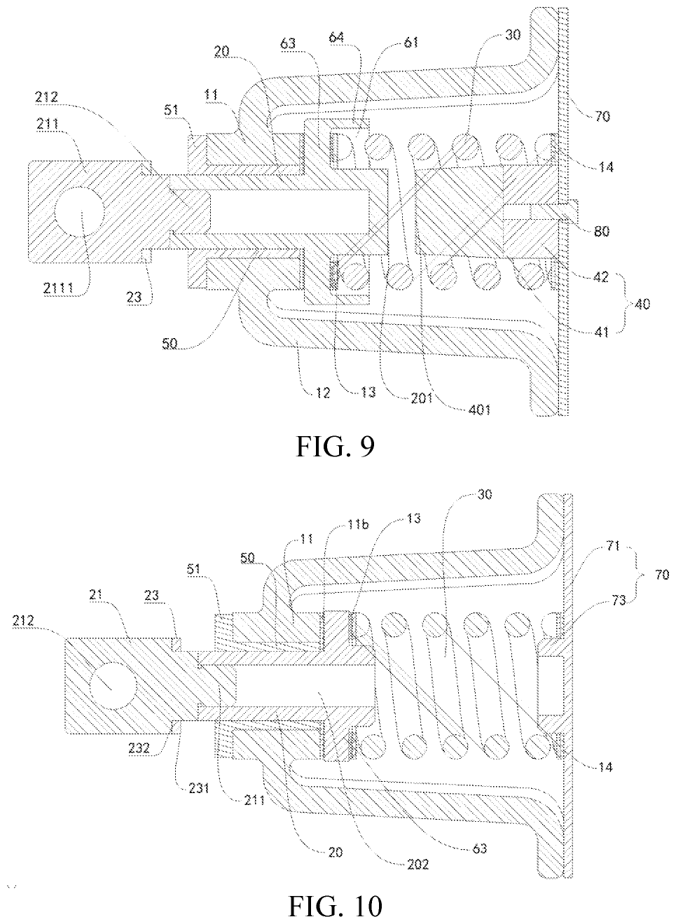

In an embodiment, as shown in FIG. 6, FIG. 8, and FIG. 9, the primary stop 40 is a columnar structure. An external force will cause the wheel shaft fixing shaft 20 to move from the outside toward the inside along the extending direction of the guide hole 11a. A stop boss 61 is fixedly connected with the inner end of the wheel shaft fixing shaft 20. When an inner end surface of the stop boss 61 contacts the outer end surface of the primary stop 40, the wheel shaft fixing shaft 20 reaches the first inner end limit position.

In another embodiment, a blind hole coaxial with the primary stop 40 may be further provided in the middle of the primary stop. A closed end of the blind hole is configured to define the first stroke of the wheel shaft fixing shaft. For example, a stop boss 61 is fixedly connected with the inner end of the wheel shaft fixing shaft 20. The stop boss 61 is arranged coaxially with the wheel shaft fixing shaft 20, an outer diameter of the stop boss 61 is not greater than an inner diameter of the blind hole, and a length of the stop boss 61 is not less than an axial length of the blind hole. An external force will cause the wheel shaft fixing shaft 20 to move from the outside toward the inside along the extending direction of the guide hole 11a, until an inner end surface of the stop boss 61 contacts the closed end of the blind hole, and then the wheel shaft fixing shaft 20 will reach the first inner end limit position. The first inner end limit position means a maximum inner end limit position where the wheel shaft fixing shaft can reach during normal operation of the primary stop 40. In these embodiments, the elastic component 30 may be a spiral spring or other types of elastic components, and the elastic component 30 is sleeved on the outer periphery of the primary stop 40.

Certainly, in other embodiments, the first inner end limit position of the wheel shaft fixing shaft 20 may be defined by the primary stop 40. For example, a blind hole is provided on the wheel shaft fixing shaft, and the primary stop 40 is a columnar structure. The first inner end limit position of the wheel shaft fixing shaft 20 may be defined through engagement between the blind hole and the wheel shaft fixing shaft. The present disclosure does not exclude various embodiments of defining the first inner end limit position of the wheel shaft fixing shaft 20 through deformation of the wheel shaft fixing shaft 20 and the primary stop 40. In these embodiments, the elastic component 30 may be a spiral spring or other types of elastic components, and the elastic component 30 is sleeved on the outer periphery of the primary stop 40.

In some embodiments, as shown in FIG. 6, FIG. 8, and FIG. 9, the primary stop 40 includes a fixing stop 42 and a flexible stop 41. An inner end of the fixing stop 42 is configured to be fixedly connected with the guide frame 210. For example, the fixing stop 42 is made of a rigid material, and the fixing stop 42 is fixedly connected with the guide frame 210 through a screw 80 or a bolt. An inner end of the flexible stop 41 is connected with an outer end of the fixing stop 42, and the flexible stop 41 is a flexible member. For example, the flexible stop 41 may be columnar, and the flexible stop is arranged coaxially with the wheel shaft fixing shaft 20.

In some embodiments, as shown in FIG. 8 and FIG. 9, an outer end surface 401 of the primary stop 40 and the inner end surface 201 of the wheel shaft fixing shaft are switched between a disengaged state and a contact state during the movement of the wheel shaft fixing shaft 20 along the extending direction of the guide hole 11a.

In another embodiment, at least one of parts of the wheel shaft fixing shaft 20 and the primary stop 40 where the wheel shaft fixing shaft and the primary stop can contact each other is made of a flexible material. For example, the flexible stop 41 is a flexible member, and the inner end of the wheel shaft fixing shaft 20 is made of a flexible material. Alternatively, the primary stop 40 is overall made of a rigid material, and the inner end of the wheel shaft fixing shaft 20 is made of a flexible material.

When the primary stop 40 limits the first inner end limit position of the wheel shaft fixing shaft, the flexible stop of or the flexible material of the inner end of the wheel shaft fixing shaft 20 can reduce vibration and avoid severe impact, which further improves the reliability and the service life of the guide wheel mounting base 100 and the lateral stability of the rail vehicle 300. Therefore, the guide wheel mounting base is applicable to urban rail transit vehicles with a large freight volume for long time running.

In some embodiments, as shown in FIG. 6, FIG. 8, and FIG. 9, the first stop further includes a secondary stop 21. The secondary stop 21 is configured to define a second stroke of the wheel shaft fixing shaft 20. The second stroke is greater than the first stroke. The secondary stop 21 is configured to define a second inner end limit position of the wheel shaft fixing shaft 20, and the second inner end limit position is closer to the guide frame. When the primary stop 40 fails, the secondary stop 21 defines the inner end limit position of the wheel shaft fixing shaft 20, which improves the operation reliability of rail vehicle.

In some embodiments, as shown in FIG. 6, FIG. 8, and FIG. 9, the secondary stop 21 is arranged on the outer end of the wheel shaft fixing shaft 20. A profection of the secondary stop 21 on a plane perpendicular to the extending direction of the guide hole 11a is denoted as a first projection, and a projection of the wheel shaft fixing shaft 20 on the plane perpendicular to the extending direction of the guide hole is denoted as a second projection. The second projection is at least partially arranged within the first projection.

In some embodiments, the secondary stop 21 includes a stop head. A projection of the stop head 211 on the plane perpendicular to the extending direction of the guide hole 11a is a first projection, and the second projection is at least partially arranged within the first projection. In this embodiment, the stop head 211 is integrally formed with the wheel shaft fixing shaft 20, as shown in FIG. 6. In an embodiment, the stop head 211 may be cylindrical or prismatic, and a maximum outer diameter of the stop head 211 is greater than an inner diameter of the guide hole 11a. In an embodiment, the secondary stop 21 is arranged coaxially with the guide hole 11a. In an embodiment, the secondary stop 21 may have other irregular shapes, such as a disc structure formed by multiple gear rods. The present disclosure does not limit the specific structure of the secondary stop.

In some embodiments, the secondary stop 21 further includes a connecting rod 212. The connecting rod 212 is threadedly connected with the wheel shaft fixing shaft, as shown in FIG. 8 and FIG. 9. A threaded hole is provided in the middle of the wheel shaft fixing shaft 20, and external threads are arranged on the connecting rod.

In some implementations, as shown in FIG. 4 and FIG. 6, a mounting hole 2111 is provided on the stop head 211. The mounting hole 2111 is configured to mount the guide wheel shaft 221. A central axis of the mounting hole 2111 is perpendicular to the axis of the wheel shaft fixing shaft 20.

In some embodiments, as shown in FIG. 6 and FIG. 8 to FIG. 11, the guide wheel mounting base 100 further includes a flexible pad 23. An outer end surface 232 of the flexible pad 23 is fitted to an inner end surface of the secondary stop 21, and an inner end surface 231 of the flexible pad 23 corresponds to an outer end surface of the buffer guide portion 11. When the secondary stop 21 limits the inner end limit position of the wheel shaft fixing shaft 20, the inner end surface 231 of the flexible pad is fitted to the outer end surface of the buffer guide portion 11, which can buffer collision and reduce the noise.

In some embodiments, as shown in FIG. 6, the flexible pad 23 may be sleeved on the wheel shaft fixing shaft 20.

As shown in FIG. 6 and FIG. 8 to FIG. 11, in some embodiments, the guide wheel mounting base 100 further includes a wear-resistant bushing 50. The wear-resistant bushing 50 is arranged between the guide hole 11a and the wheel shaft fixing shaft 20, the guide hole 11a is sleeved outside the wear-resistant bushing 50, and the wear-resistant bushing 50 is sleeved outside the wheel shaft fixing shaft 20. The wheel shaft fixing shaft 20 and the guide hole 11a are engaged with each other through the wear-resistant bushing 50, which avoids direct engagement between the wheel shaft fixing shaft 20 and the guide hole 11a. In addition, the wear resistance of the wear-resistant bushing 50 reduces the wear of the wheel shaft fixing shaft 20 and the guide hole 11a, and optimizes the force environment of the wheel shaft fixing shaft 20 and the guide hole 11a, thereby improving the service lives of the wheel shaft fixing shaft 20 and the mounting bracket 10, and reducing the machining precision requirements for the wheel shaft fixing shaft 20 and the guide hole 11a. Furthermore, since the wear-resistant bushing 50 can be easily replaced after failing, the overall service life of the guide wheel mounting base 100 is further improved.

In some embodiments, multiple grooves or openings in a mesh distribution are arranged on an inner surface of the wear-resistant bushing 50. The multiple grooves or openings are filled with lubricating materials, which provides lubrication during the movement of the wheel shaft fixing shaft 20, so that the wear of the wheel shaft fixing shaft 20 and the wear-resistant bushing 50 is further reduced, and the force environment of the wheel shaft fixing shaft 20 and the guide hole 11a is optimized, thereby improving the service lives of the wheel shaft fixing shaft 20 and the mounting bracket 10.

In some embodiments, the wear-resistant bushing 50 is made of a copper alloy material, so that the wear-resistant bushing 50 has desirable thermal conductivity and a certain heat dissipation capacity.

In some embodiments, a hardness of the material of the wear-resistant bushing 50 is less than that of the material of the buffer guide portion 11. In an embodiment, the wear-resistant bushing 50 is made of rubber. When the wear-resistant bushing 50 is not deformed, a hole diameter of a central hole of the wear-resistant bushing 50 is slightly less than the outer diameter of the wheel shaft fixing shaft, which keeps the outer peripheral surface of the wheel shaft fixing shaft 20 in contact with an inner peripheral surface of the wear-resistant bushing 50 even when the guide wheel is subjected to external forces from different directions, that is, even when the axis of the wheel shaft fixing shaft 20 is slightly offset. At least part of the outer peripheral surface of the wheel shaft fixing shaft 20 is in contact with at least part of the inner peripheral surface of the wear-resistant bushing 50.

In some embodiments, the hardness of the material of the wear-resistant bushing 50 is less than that of the material of the wheel shaft fixing shaft 20. In an embodiment, the wear-resistant bushing 50 is made of rubber. When the wear-resistant bushing 50 is not deformed, a hole diameter of a central hole of the wear-resistant bushing 50 is slightly less than the outer diameter of the wheel shaft fixing shaft 20, which keeps the outer peripheral surface of the wheel shaft fixing shaft 20 in contact with an inner peripheral surface of the wear-resistant bushing 50 even when the guide wheel is subjected to external forces from different directions, that is, even when the axis of the wheel shaft fixing shaft 20 is slightly offset. At least part of the outer peripheral surface of the wheel shaft fixing shaft 20 is in contact with at least part of the inner peripheral surface of the wear-resistant bushing 50.

As shown in FIG. 6 and FIG. 8 to FIG. 11, in some embodiments, a limiting turnup 51 is arranged on the wear-resistant bushing 50, an inner side of the limiting turnup 51 is engaged with the outer end surface of the buffer guide portion 11, and an outer end surface of the limiting turnup 51 is arranged opposite to an inner end surface of the flexible pad. When the secondary stop reaches the inner end limit position of the wheel shaft fixing shaft, the inner end surface of the flexible pad contacts the outer end surface of the limiting turnup, which improves the reliability and service life of the guide wheel mounting base 100.

In some embodiments, the second stop 60 is fixedly connected with the wheel shaft fixing shaft 20. In an embodiment, as shown in FIG. 8 to FIG. 11, the second stop 60 is integrally formed with the wheel shaft fixing shaft 20. In another embodiment, as shown in FIG. 6, the second stop 60 is threadedly connected with the wheel shaft fixing shaft 20.

In some embodiments, an inner end of the elastic component 30 is sleeved on an outer periphery of the primary stop 40, and an outer end of the elastic component 30 is sleeved on the second stop 60.

In some embodiments, as shown in FIG. 8, the second stop includes a baffle 63. The elastic component 30 is connected with the baffle 63. A projection of the elastic component 30 on a plane perpendicular to the extending direction is denoted as a third projection. A projection of the baffle 63 on the plane perpendicular to the extending direction is denoted as a fourth projection. The third projection is at least partially arranged within the fourth projection. A projection of the wheel shaft fixing shaft 20 on the plane perpendicular to the extending direction is denoted as a first projection. The first projection is at least partially arranged within the third projection. In an embodiment, the baffle 63 is threadedly connected with the wheel shaft fixing shaft 20. In another embodiment, the baffle 63 is integrally formed with the wheel shaft fixing shaft 20.

In some embodiments, as shown in FIG. 6, the second stop 60 further includes a stop boss 62. The stop boss 62 is fixedly connected with the baffle 63 and extends inward away from the baffle 63. The elastic component 30 is sleeved on an outer periphery of the stop boss 62. The outer end of the elastic component 30 abuts against the baffle 63. In these embodiments, the elastic component 30 may be a coil spring, but other feasible solutions are not excluded. In an embodiment, a threaded hole is provided on the stop boss, external threads are arranged on an outer periphery of the inner end of the wheel shaft fixing shaft 20, and the stop boss 62 is threadedly connected with the wheel shaft fixing shaft 20.

In some embodiments, as shown in FIG. 6 and FIG. 9, the second stop 60 further includes a rib. The rib 64 is arranged on an outer edge of the baffle 63, and the rib 64 extends inward in a direction parallel to the extending direction to form a groove 61 for accommodating the elastic component. The elastic component 30 is arranged in the groove 61, and a component of a force on the guide wheel or the guide mounting shaft is not zero in a direction perpendicular to the extending direction wheel shaft fixing shaft. The rib can reduce the radial offset of the elastic component, prevent the elastic component 30 from colliding with an inner wall of the mounting bracket 210, further reduce the noise caused by the external force, and improve the reliability of the guide wheel mounting base.

In an embodiment, as shown in FIG. 9, the baffle 63 is integrally formed with the wheel shaft fixing shaft 20, and the rib 64, the baffle 63, and the wheel shaft fixing shaft 20 jointly form the groove 61 with an opening facing inward.

In another embodiment, as shown in FIG. 4, the second stop includes a stop boss 62, and the rib 64, the baffle 63, and the stop boss 62 jointly form the groove 61 with an opening facing inward.

In some embodiments, the baffle 63 is circular, the rib 64 is cylindrical along the outer edge of the baffle 63, the rib 64 extends inward in the direction parallel to the extending direction, the stop boss 62 is cylinder-shaped or cylindrical, and the groove 61 is an annular groove. The outer end of the elastic component 30 abuts against an inner end of the baffle. The circular baffle can uniformize a force on the elastic component 30 in an axial direction, and the annular rib 64 can limit the elastic component 30 in the radial direction more effectively.

In some embodiments, the functions of the primary stop 40 and the secondary stop 21 may be transposed. That is to say, the primary stop 40 is configured to define the second stroke of the wheel shaft fixing shaft 20, and the secondary stop 21 is configured to define the first stroke of the wheel shaft fixing shaft. The second stroke is greater than the first stroke. It may be understood that, in a normal working condition, the secondary stop 21 is configured to define the inner end limit position of the wheel shaft fixing shaft 20. When the secondary stop 21 fails or the flexible pad fails, the primary stop 40 is configured to define the inner end limit position of the wheel shaft fixing shaft 20.

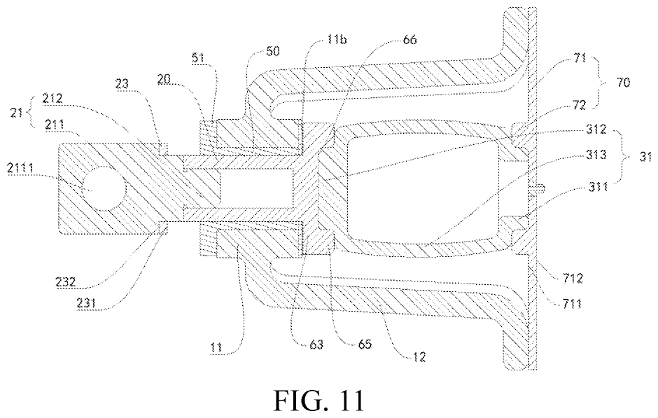

In some embodiments, the secondary stop 21 may be configured to define the inner end limit position of the wheel shaft fixing shaft 20 alone. As shown in FIG. 10 and FIG. 11, only one limit stage is provided for the wheel shaft fixing shaft in a direction from the outside to the inside.

In some embodiments, as shown in FIG. 11, the elastic component 30 is an airbag 31. An inner end of the airbag 31 is configured to connect with the guide frame, the outer end of the elastic component 31 is connected with the second stop 60, and the first stop is arranged on the outer end of the wheel shaft fixing shaft 20. In an embodiment, the airbag includes an inner protruding portion 311, an outer protruding portion 312, and an airbag body 313 arranged between the inner protruding portion 311 and the outer protruding portion 312. An airbag fixing portion 65 is arranged on the inner end of the second stop 60, and a recessed portion 66 is arranged on the airbag fixing portion 65. The outer protruding portion 312 is inserted into the recessed portion 66.

As shown in FIG. 4 and FIG. 6 to FIG. 8, in some embodiments, a stop gasket 11b is arranged on an inner end surface of the buffer guide portion 11, which can avoid direct collision when the outer end surface of the second stop 60 comes into contact fit with the inner end surface of the buffer guide portion 11, so that the service life of the guide wheel mounting base 100 is improved.

As shown in FIG. 4 and FIG. 6 to FIG. 9, in some embodiments, the guide wheel mounting base 100 further includes a mounting plate 70. The inner end of the mounting bracket 10, the inner end of the elastic component 30, and the inner end of the primary stop 40 are all connected with the guide frame 210 through the mounting plate 70. Arranging the mounting plate 70 can offset the machining and mounting errors and reduce the machining precision requirements to some extent, thereby reducing the costs, and can reduce the contact stress between the mounting bracket 10, the elastic component 30, and the primary stop 40 and the guide frame 210, thereby improving the service life of the guide wheel mounting base 100. In an embodiment, the mounting plate 70 is a flexible plate. In another embodiment, a first small flexible board 14 is mounted to an inner side surface of the mounting plate 70, and the outer end of the elastic component abuts against the small flexible board 14. In this embodiment, the mounting plate 70 may be either a flexible plate or a rigid plate. Since the mounting plate is a flexible plate or the first small flexible board 14 is arranged on the inner side surface of the mounting plate, further buffering and noise reduction can be provided when the elastic component is axially compressed. In particular, when the elastic component is a metal spring, noise of collision between the spring and the mounting plate can be reduced.

In some embodiments, as shown in FIG. 10, an outer side surface of the first small flexible board 14 is fitted to the inner side surface of the mounting plate. In an embodiment, an elastic component mounting portion 73 that protrudes outward is arranged on the inner side surface of the mounting plate. The inner end of the elastic component is sleeved on an outer periphery of the elastic component mounting portion 73, the first small flexible board 14 is sleeved on the outer periphery of the elastic component mounting portion 73, and the inner end of the elastic component abuts against the outer side surface of the first small flexible board 14.

In some embodiments, as shown in FIG. 10, the mounting plate includes a plate body 71, and the elastic component mounting portion 73 is integrally formed with the plate body 71. In an embodiment, the elastic component mounting portion is arranged on an outer side surface 711 of the plate body.

In some embodiments, as shown in FIG. 10, the guide wheel mounting base 100 further includes a second small flexible board 13. The second small flexible board 13 is arranged on the outer end of the elastic component 30, and the outer end of the elastic component 30 abuts against the inner side surface of the second small flexible board 13. In an embodiment, the second small flexible board 13 is sleeved on an outer peripheral surface of the inner end of the wheel shaft fixing shaft 20. In another embodiment, the second small flexible board 13 is sleeved on an outer peripheral surface of the stop boss 62.

As shown in FIG. 6, FIG. 8, and FIG. 9, in some embodiments, the primary stop 40 includes a flexible stop 41 and a fixing stop 42, and the flexible stop 41 is connected with the guide frame 210 through the fixing stop 42. In some embodiments, the flexible stop 41 is supported by a rubber and is fixed to the fixing stop 42 through a vulcanization process, and the fixing stop 42 is connected with the mounting plate 70 through bolts.

As shown in FIG. 7, in some embodiments, the mounting bracket 10 further includes two support portions 12. The two support portions 12 are symmetrically arranged with respect to the buffer guide portion 11. For example, the two support portions may be symmetrically arranged along the extending direction of the center of the guide hole 11a. Outer ends of the two support portions 12 are both connected with the buffer guide portion 11, and inner ends of the two support portions 12 are both configured to connect with the guide frame 210. Symmetrically arranging the support portions 12 not only ensures the support reliability of the mounting bracket 10, but also realizes a light weight.

As shown in FIG. 7, in some embodiments, each of the support portions 12 includes a first turnup 12a, a support plate 12b, and a second turnup 12c connected in sequence. The first turnup 12a of each of the support portions 12 extends toward the other support portion 12, and the first turnup 12a is connected with the buffer guide portion 11. The second turnup 12c of each of the support portions 12 extends away from the other support portion 12, and the second turnup 12c is connected with the guide frame 210 or the mounting plate 70. Arranging the turnup structure optimizes the force environment of the support portion 12 and facilitates the mounting of the support portion 12.

As shown in FIG. 7, in some embodiments, the support plate 12b is an arcuate plate, and the support plate 12b protrudes away from a center of the guide wheel mounting base 100. The arcuate support plate 12b realizes a larger support strength of the support portion 12.

As shown in FIG. 6 and FIG. 7, in some embodiments, a distance between the two support portions 12 gradually increases in a direction from the outer end of the mounting bracket 10 to the inner end of the mounting bracket 10, so that the connection between the mounting bracket 10 and the guide frame 210 is more stable.

As shown in FIG. 5, in some embodiments, the guide wheel 220 includes a guide wheel shaft 221 and a guide wheel body 222, and the guide wheel shaft 221 extends through the guide wheel body 222. At least two guide wheel mounting bases 100 are arranged. The two guide wheel mounting bases 100 are respectively arranged above and below the guide wheel body 222, and the outer ends of the wheel shaft fixing shafts 20 of the two guide wheel mounting bases 100 are respectively connected with two ends of the guide wheel shaft 221. Arranging the guide wheel mounting bases 100 on both ends of the guide wheel shaft 221 improves the mounting stability of the guide wheel 220. As shown in FIG. 4, in some embodiments, four guide wheels 220 are arranged, and the four guide wheels 220 are in a rectangular distribution. Each of the guide wheels 220 is connected with the guide frame 210 through the two guide wheel mounting bases 100.

During the operation of the rail vehicle 300, especially during turning, the guide wheel 220 may be subjected to forces from various directions, which results in an obvious bump feeling. The primary stop 40 is arranged to stop the movement of the wheel shaft fixing shaft 20 when a compression amount of the elastic component 30 reaches a specific amount, so as to avoid excessive compression of the elastic component 30 and avoid impact on the normal operation of the guide wheel 220. Moreover, the flexible structure of the primary stop 40 provides vibration attenuation during the contact between the wheel shaft fixing shaft 20 and the primary stop 40, which further improves the reliability and the service life of the guide wheel mounting base 100 and the lateral stability of the rail vehicle 300. Therefore, the rail vehicle 300 can be used as an urban rail transit vehicle with a large freight volume for long time running.

Other compositions and operations of the guide wheel mounting base 100, the guide device 200, and the rail vehicle 300 in the embodiments of the present disclosure are known to those of ordinary skill in the art, and therefore are not described in detail herein.

In the descriptions of this specification, descriptions using reference terms “an embodiment”, “some embodiments”, “an exemplary embodiment”, “an example”, “a specific example”, or “some examples” mean that specific features, structures, materials, or characteristics described with reference to the embodiment or example are included in at least one embodiment or example of the present disclosure. In this specification, schematic descriptions of the foregoing terms do not necessarily refer to the same embodiment or example. In addition, the described specific features, structures, materials, or characteristics may be combined in a proper manner in any one or more embodiments or examples.

Although the embodiments of the present disclosure have been shown and described, a person of ordinary skill in the art should understand that various changes, modifications, replacements, and variations may be made to the embodiments without departing from the principles and spirit of the present disclosure, and the scope of the present disclosure is as defined by the appended claims and their equivalents.

What is claimed is:

1. A guide wheel mounting base, configured to mount a guide wheel, wherein the guide wheel is mounted to a guide wheel shaft; and the guide wheel mounting base comprises:
a mounting bracket, wherein a guide hole is provided on the mounting bracket; and
a wheel shaft fixing shaft, wherein an outer end of the wheel shaft fixing shaft is configured to connect with the guide wheel shaft; a central axis of the guide wheel shaft is perpendicular to a central axis of the wheel shaft fixing shaft; an inner end of the wheel shaft fixing shaft extends through the guide hole; and in an extending direction of the guide hole, a space is reserved between the inner end of the wheel shaft fixing shaft and an inner end of the mounting bracket for the wheel shaft fixing shaft to move back and forth along the extending direction of the guide hole.

2. The guide wheel mounting base according to claim 1, wherein the mounting base further comprises:
an elastic component, configured to push the wheel shaft fixing shaft to move from inside toward outside along the extending direction of the guide hole when the wheel shaft fixing shaft reaches an inner end limit position;
a first stop, configured to define the inner end limit position of the wheel shaft fixing shaft in the extending direction of the guide hole; and
a second stop, configured to define an outer end limit position of the wheel shaft fixing shaft in the extending direction of the guide hole.

3. The guide wheel mounting base according to claim 2, wherein the first stop comprises a primary stop; and the primary stop is configured to define a first stroke of the wheel shaft fixing shaft.

4. The guide wheel mounting base according to claim 3, wherein the first stop further comprises a secondary stop; the secondary stop is configured to define a second stroke of the wheel shaft fixing shaft; and the second stroke is greater than the first stroke.

5. The guide wheel mounting base according to claim 1, wherein the mounting base further comprises:
a wear-resistant bushing, arranged in the guide hole and sleeved on an outer periphery of the wheel shaft fixing shaft.

6. The guide wheel mounting base according to claim 1, wherein the mounting base further comprises:
a wear-resistant bushing, arranged in the guide hole and sleeved on an outer periphery of the wheel shaft fixing shaft, wherein a limiting turnup is arranged on an outer end of the wear-resistant bushing; an inner side surface of the limiting turnup is fitted to an outer end surface of the mounting bracket; and an outer side surface of the limiting turnup is arranged opposite to an inner end surface of the secondary stop.

7. The guide wheel mounting base according to claim 2, wherein the second stop is fixedly connected with the wheel shaft fixing shaft; an inner end of the elastic component is arranged on the primary stop, and an outer end of the elastic component is arranged on the second stop.

8. The guide wheel mounting base according to claim 7, wherein the second stop comprises:
a baffle, wherein the elastic component is connected with the baffle; a projection of the elastic component on a plane perpendicular to the extending direction is denoted as a third projection; a projection of the baffle on the plane perpendicular to the extending direction is denoted as a fourth projection; the third projection is at least partially arranged within the fourth projection; a projection of the wheel shaft fixing shaft on the plane perpendicular to the extending direction is denoted as a first projection; and the first projection is at least partially arranged within the third projection.

9. The guide wheel mounting base according to claim 8, wherein the second stop further comprises:
a stop boss, fixedly connected with the baffle and extending inward away from the baffle, wherein the elastic component is sleeved on an outer periphery of the stop boss; and the outer end of the elastic component abuts against the baffle.

10. The guide wheel mounting base according to claim 9, wherein the second stop further comprises:
a rib, arranged on an outer edge of the baffle and extending inward along a direction parallel to the extending direction.

11. The guide wheel mounting base according to claim 9, wherein during a movement of the wheel shaft fixing shaft along the extending direction of the guide hole, the primary stop and the stop boss are switched between a disengaged state and a contact state, and at least one of parts of the stop boss and the primary stop where the stop boss and the primary stop contact each other is made of a flexible material.

12. The guide wheel mounting base according to claim 2, further comprising:
a mounting plate, wherein the inner end of the mounting bracket is connected with the mounting plate; and an inner end of an elastic component abuts against the mounting plate.

13. The guide wheel mounting base according to claim 12, wherein the mounting plate is a flexible plate, or a small flexible plate is mounted to an inner side surface of the mounting plate.

14. A guide device, applicable to a rail vehicle, comprising:
a guide frame;
a guide wheel, mounted to a guide wheel shaft and configured to engage with a side surface of a rail; and
a guide wheel mounting base, wherein the guide wheel is mounted to the guide frame through the guide wheel mounting base; and the guide wheel mounting base comprises:
a mounting bracket, wherein a guide hole is provided on the mounting bracket;
a wheel shaft fixing shaft, wherein an outer end of the wheel shaft fixing shaft is configured to connect with the guide wheel shaft; a central axis of the guide wheel shaft is perpendicular to a central axis of the wheel shaft fixing shaft; an inner end of the wheel shaft fixing shaft extends through the guide hole; and in an extending direction of the guide hole, a space i s reserved between planes where the inner end of the wheel shaft fixing shaft and an inner end of the mounting bracket are respectively located for the wheel shaft fixing shaft to move back and forth along the extending direction of the guide hole;
an elastic component, configured to push the wheel shaft fixing shaft to move from inside toward outside along the extending direction of the guide hole when the wheel shaft fixing shaft reaches an inner end limit position;
a first stop, configured to define the inner end limit position of the wheel shaft fixing shaft in the extending direction of the guide hole; and
a second stop, configured to define an outer end limit position of the wheel shaft fixing shaft in the extending direction of the guide hole.

15. The guide device according to claim 14, wherein the mounting bracket comprises:
a buffer guide portion, wherein a guide hole is provided on the buffer guide portion; and
support portions, wherein outer ends of the support portions are connected with the buffer guide portion, and inner ends of the support portions are directly or indirectly connected with the guide frame.

16. A rail vehicle, configured to travel on a rail, comprising:
an axle; and
guide devices, connected with the axle and each comprising:
a guide frame;
a guide wheel, mounted to a guide wheel shaft; and
a guide wheel mounting base, wherein the guide wheel is mounted to the guide frame through the guide wheel mounting base; and the guide wheel mounting base comprises:
a mounting bracket, wherein a guide hole is provided on the mounting bracket;
a wheel shaft fixing shaft, wherein an outer end of the wheel shaft fixing shaft is configured to connect with the guide wheel shaft; a central axis of the guide wheel shaft is perpendicular to a central axis of the wheel shaft fixing shaft; the wheel shaft fixing shaft is arranged inside the guide hole; and in an extending direction of the guide hole, a space is reserved between an inner end of the wheel shaft fixing shaft and an inner end of the mounting bracket for the wheel shaft fixing shaft to move back and forth along the extending direction of the guide hole;
an elastic component, configured to push the wheel shaft fixing shaft to move from inside toward outside along the extending direction of the guide hole when the wheel shaft fixing shaft reaches an inner end limit position;
a first stop, configured to define the inner end limit position of the wheel shaft fixing shaft in the extending direction of the guide hole; and
a second stop, configured to define an outer end limit position of the wheel shaft fixing shaft in the extending direction of the guide hole.

17. The rail vehicle according to claim 16, wherein the first stop comprises:
a primary stop, configured to define a first stroke of the wheel shaft fixing shaft; and
a secondary stop, configured to define a second stroke of the wheel shaft fixing shaft, wherein
the second stroke is greater than the first stroke.

18. The rail vehicle according to claim 17, wherein the secondary stop is arranged on the outer end of the wheel shaft fixing shaft; the primary stop is arranged on the inner end of the wheel shaft fixing shaft; and the secondary stop, the wheel shaft fixing shaft, and the primary stop are coaxially arranged.

19. The rail vehicle according to claim 16, wherein the first stop comprises the primary stop; the primary stop is coaxially arranged with the wheel shaft fixing shaft; the primary stop is arranged on an inner side of the wheel shaft fixing shaft; a space is reserved between the primary stop and the wheel shaft fixing shaft for the wheel shaft fixing shaft to move back and forth along the extending direction of the guide hole; and at least one of an outer end of the primary stop and the inner end of the wheel shaft fixing shaft is made of a flexible material.

20. The rail vehicle according to claim 16, wherein each of the guide devices comprises four guide wheels, the four guide wheels are distributed on side surfaces of the guide frame in pairs along an advancing direction of the rail vehicle, and the guide wheel is mounted on the wheel shaft fixing shaft by a guide wheel shaft.
